(19) United States
(12) Patent Application Publication
(10) Pub. No.: US 2006/0180579 A1
(43) Pub. Date: Aug. 17, 2006

(54) Multidirectional cutting chuck

(75) Inventors: Ross Popescu, Morgan Hill, CA (US); Shan Jiang, Morgan Hill, CA (US)

Correspondence Address: BEYER WEAVER & THOMAS LLP, P.O. BOX 70250, OAKLAND, CA, 94612-0250, US

(73) Assignee: TOWA Intercon Technology, Inc.

(21) Appl. No.: 11/056,544

(22) Filed: Feb. 11, 2005

(51) Int. Cl. B23K 15/00

(52) U.S. Cl. 219/121.18

(57) ABSTRACT

A single multidirectional chuck for use with a cutting beam such as a fluid jet is disclosed. The single multidirectional chuck includes a first set of cutting slots oriented in a first direction and a second set of cutting slots oriented in a second direction that is transverse to the first direction. One set of cutting slots extends entirely through the chuck so that the cutting beam may pass therethrough. The other set of cutting slots, which are transverse to the first set, only extend partially into the chuck. The partially extended cutting slots each provide a space that leads to a sacrificial member housed with a cavity in the single chuck. During a cutting operation, the cutting beam passes through the partially extended cutting slots and bombards the sacrificial member. The sacrificial member is configured to sacrifice itself in order to protect the structural components of the chuck. The sacrificial member is also configured to temper and redirect the flow of the fluid jet so that it can be exhausted out of the chuck as for example through the fully extended cutting slots.

### CROSS REFERENCE TO RELATED APPLICATION

This application is related to U.S. patent application Ser. No. 10/661,385 entitled “JET SINGULATION”, filed on Sep. 12, 2003, which is incorporated herein by reference.

This application is related to U.S. patent application Ser. No. 10/930,695 entitled “JET SINGULATION”, filed on Aug. 30, 2004, which is incorporated herein by reference.

### FIELD OF THE INVENTION

The invention generally relates to integrated circuit processing equipment. More particularly, the invention relates to an improved apparatus and method of singulating a substrate into a plurality of component parts, and even more particularly to methods and devices for holding a work piece during singulation.

### BACKGROUND OF THE INVENTION

Semiconductor manufacturing includes many processing steps. In front side processing, several hundred dies are created on wafers using various techniques such as photolithography, etching and deposition. Once the dies are created, each device is tested to ensure that it is operating properly. After the test, the wafer is separated into individual dies. The separation process is typically implemented in multiple steps including for example scoring and sawing. Both steps include cutting straight lines into the wafer. Scoring, such as for example saw or laser scoring, is implemented to reduce chipping during the final sawing process. Sawing is typically performed with saw blades that cut through the scored wafer to form the individual dies.

Once separated, the bad dies are discarded and the good dies are passed to backside processing. In backside processing, the good dies are packaged either separately or together. In the later case, multiple dies are positioned in rows and columns on a substrate and thereafter the entire substrate is enclosed in a ceramic or plastic material (e.g., packaged). Once the packaging step is completed, a singulation procedure is typically performed to separate the individual integrated circuit packages from the substrate. In most cases, the substrate is held in place while one or more saw blades cut straight lines through the substrate to form the individual integrated circuit packages.

While dicing wafers and substrates with blades has worked well, there are desired improved apparatuses and methods for separating these components into a plurality of discrete parts.

### SUMMARY OF THE INVENTION

The invention relates, in one embodiment, to a chuck having a top surface for receiving and retaining a planar work piece thereon during a cutting operation, and a plurality of cutting slots disposed through the top surface. The cutting slots are configured to receive a cutting beam therein during a cutting operation. At least a first set of the cutting slots are configured to intersect an opening, which is disposed inside the chuck, and which includes a sacrificial member therein. The sacrificial member provides cutting resistance to the cutting beam when the cutting beam intersects the sacrificial member through the cutting slots.

The invention relates, in one embodiment, to a single multidirectional vacuum chuck configured to hold a work piece and parts cut therefrom before, during and after singulation with a cutting beam. The single multidirectional vacuum chuck includes a base having a plurality of vacuum pedestals and a plurality of cutting slots disposed between the vacuum pedestals. Each of the vacuum pedestals includes a vacuum port. Furthermore, a first set of cutting slots are oriented in a first direction and a second set of cutting slots are oriented in a second direction that is transverse to the first direction. The first set of cutting slots are configured to extend entirely through the base such that the cutting beam passes entirely through the base during a cutting operation. The second set of cutting slots are configured to extend partially into the base. The second set of cutting slots opening up to openings located within the base. The openings include removable sacrificial members therein that protect the structural integrity of the base and that temper and redirect the cutting beam out of the base.

The invention relates, in one embodiment, to a plurality of integrated circuit devices formed by a singulation method that includes providing a single multidirectional chuck having a first set of cutting slots oriented in a first direction and a second set of cutting slots oriented in a second direction such that they cross the first set of cutting slots. At least the second set of cutting slots provide paths to sacrificial members located inside the chuck. The method also includes disposing a planar work piece on the single multidirectional chuck. The planar work piece has the plurality of integrated circuit devices formed thereon. The method further includes holding the planar work piece against an upper surface of the single multidirectional chuck with a vacuum. The method additionally includes generating a cutting beam and cutting the work piece into the plurality of integrated circuit devices with the cutting beam while the work piece is held against the upper surface of the single multidirectional chuck. The cutting beam is directed about the cutting slots in order to separate the plurality of integrated circuit devices from the work piece. The cutting beam is configured to intersect the sacrificial members when the cutting beam is directed though the second set of cutting slots.

The invention relates, in one embodiment, to a method of cutting with a cutting beam. The method includes providing a retention force for holding a work piece on a surface. The method also includes receiving the cutting beam through openings in the surface and against a sacrificial member disposed underneath the surface.

### BRIEF DESCRIPTION OF THE DRAWINGS

The invention may best be understood by reference to the following description taken in conjunction with the accompanying drawings in which:

FIG. 1A is a side elevation view, in cross section, of a chuck, in accordance with one embodiment of the present invention.

FIG. 1B is a side elevation view, in cross section, of a chuck, in accordance with one embodiment of the present invention.

FIG. 1C is a top view of a cutting slot, in accordance with one embodiment of the present invention.

FIG. 1D is a top view of a cutting slot, in accordance with one embodiment of the present invention.

FIG. 1E is a top view of a chuck, in accordance with one embodiment of the present invention.

FIG. 2A is a perspective diagram of a single multidirectional chuck, in accordance with one embodiment of the present invention.

FIG. 2B is a perspective diagram of a single multidirectional chuck holding a work piece, in accordance with one embodiment of the present invention.

FIG. 3 is a top view diagram of the chuck shown in FIG. 2, in accordance with one embodiment of the present invention.

FIG. 4 is an exploded perspective diagram of the chuck shown in FIG. 2, in accordance with one embodiment of the present invention.

FIG. 5 is a side elevation view, in cross section, of the chuck shown in FIG. 3 (taken along lines 5-5′), in accordance with one embodiment of the present invention.

FIG. 6 is a side elevation view, in cross section, of the chuck shown in FIG. 3 (taken along lines 6-6′), in accordance with one embodiment of the present invention.

FIG. 7 is a top view, in cross section, of the chuck shown in FIG. 5 (taken along lines 7-7′), in accordance with one embodiment of the present invention.

FIG. 8 is a side elevation view, in cross section, of the chuck shown in FIG. 3 (taken along lines 8-8′), in accordance with one embodiment of the present invention.

FIG. 9 is a side elevation view, in cross section, of the chuck shown in FIG. 3 (taken along lines 9-9′), in accordance with one embodiment of the present invention.

FIG. 10 is a broken away perspective view of the chuck shown in FIG. 1, in accordance with one embodiment of the present invention.

FIG. 11 is a broken away perspective view of the chuck shown in FIG. 1, in accordance with one embodiment of the present invention.

FIG. 12 is a top view diagram of a pedestal, in accordance with one embodiment of the present invention.

FIG. 13 is a simplified block diagram of a cutting apparatus in accordance with one embodiment of the present invention.

FIG. 14A is a simplified perspective diagram of a fine beam cutting through a substrate to form individual packaged devices, in accordance with one embodiment of the present invention.

FIG. 14B is a simplified perspective diagram of a fine beam cutting through a substrate to form photonic devices, in accordance with one embodiment of the present invention.

FIG. 15 is a simplified diagram of a singulation engine, in accordance with one embodiment of the present invention.

### DETAILED DESCRIPTION OF THE INVENTION

In recent times, water jet singulation has come to the forefront of singulation technologies. In water jet singulation, a cutting beam that contains an abrasive and fluid is generated to cut through large components so as to produce smaller components. Singulation systems such as these are particularly suitable for singulating wafers and substrates so as to produce dies, unpackaged chips, packaged chips, and the like. Water jet singulation provides many benefits over traditional blade sawing. For example, it is capable of cutting smaller parts, it reduces consumable costs associated with blade wear, and it provides intricate cutting paths such as curvilinear, angles and stepped sections, which saw blades do not readily accommodate. One such water jet singulation system is disclosed in U.S. patent application Ser. No. 10/661,385, which is herein incorporated by reference.

Because of the configuration of the cutting beam, the work piece holder or chuck can be difficult to configure, i.e., there must be an open space underneath the work piece where the cutting beam can pass after it cuts through the work piece. If not, the cutting beam will try to cut an opening through the chuck and as a result the chuck may be damaged. In most cases, a dual chuck system is used. Each chuck in the dual chuck system includes cutting slots that extend entirely though the chuck thereby allowing the cutting beam to pass through the chuck during a cutting operation. Together the cutting slots form the desired cutting path for dicing work piece into its many parts. In most cases, the first chuck includes cutting slots in a first direction and the second chuck includes cutting slots in a second direction that is transverse to the first direction. For example, the first chuck may include cutting slots in the x direction and the second chuck may include cutting slots in the y direction. During a cutting sequence, a first set of cuts is made on the first chuck and thereafter the work piece transferred to the second chuck so that the second set of cuts can be made. Because the cuts are transverse to one another, the parts are separated from the work piece. A chuck such as this may also be found in U.S. patent application Ser. No. 10/661,385, which was mentioned above.

While dual systems may work well, it would be desirable to utilize a single chuck in order to increase throughput, and precision. In dual chuck systems, the work piece may be damaged during transfer from one chuck to the other chuck. This may be due in part to the fact that the substrate has been cut and therefore it is much weaker and has the propensity to break. Furthermore, transferring from one chuck to another takes time, which reduces throughput, and typically requires specialized transfer mechanisms, which can add costs and complexity to the singulation system.

In lieu of the above, the present invention discloses a single multidirectional chuck for use with a cutting beam such as a fluid jet. The single multidirectional chuck includes a first set of cutting slots oriented in a first direction and a second set of cutting slots oriented in a second direction that is transverse to the first direction. One set of cutting slots extends entirely through the chuck so that the cutting beam may pass therethrough. The other set of cutting slots, which are transverse to the first set, only extend partially into the chuck. The partially extended cutting slots each provide a space that leads to a sacrificial member housed with a cavity in the single chuck. During a cutting operation, the cutting beam passes through the partially extended cutting slots and bombards the sacrificial member. The sacrificial member is configured to sacrifice itself in order to protect the structural components of the chuck. The sacrificial member is also configured to temper and redirect the flow of the fluid jet so that it can be exhausted out of the chuck as for example through the fully extended cutting slots.

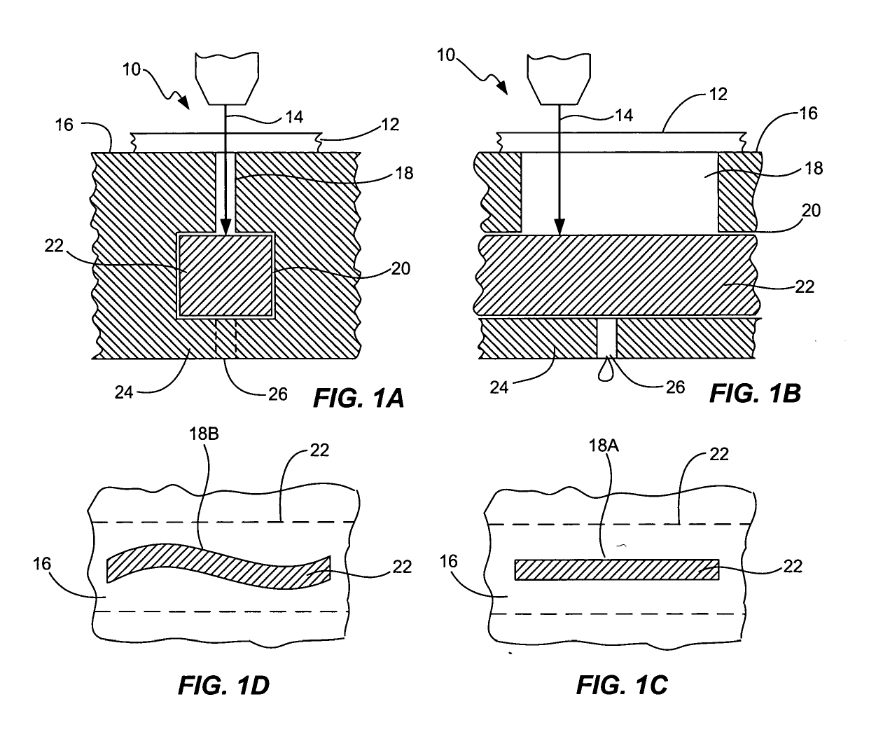

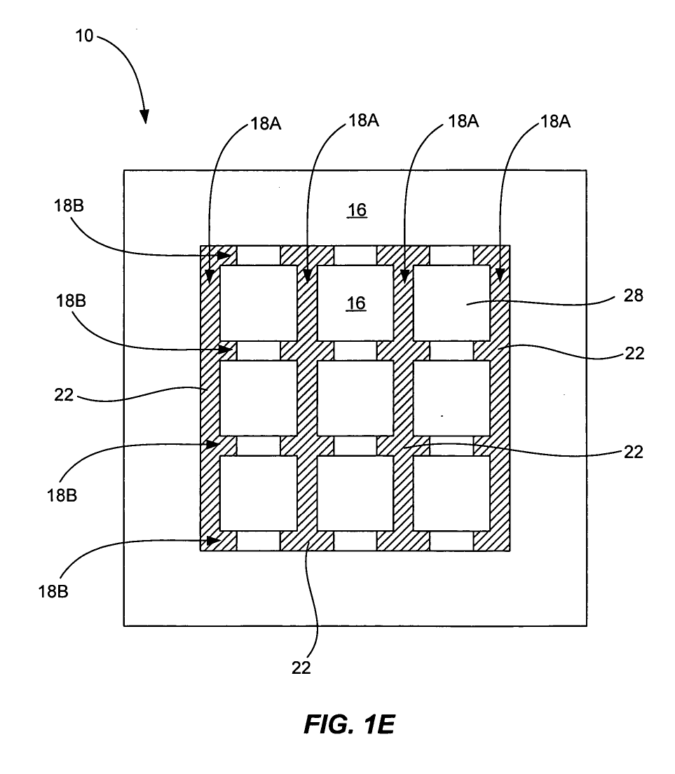

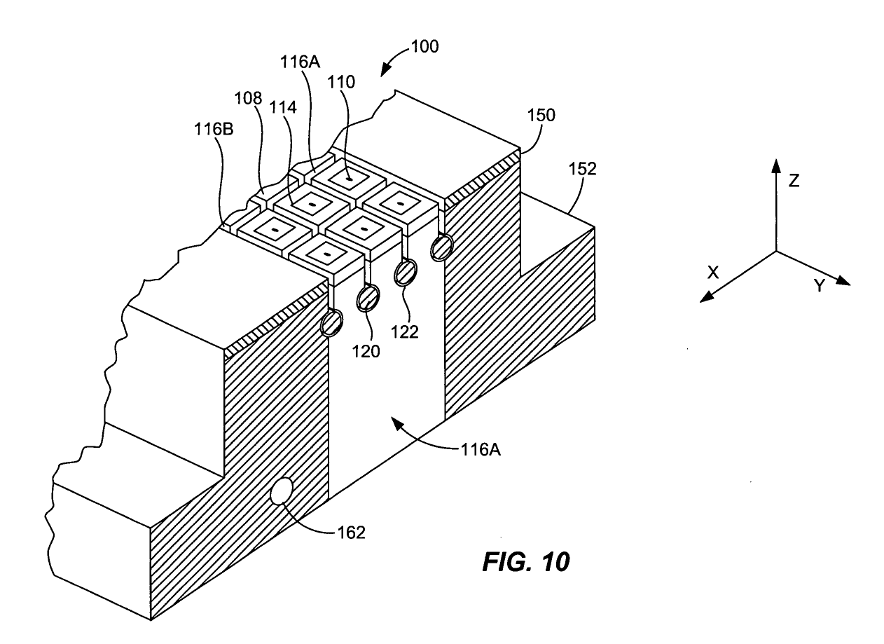

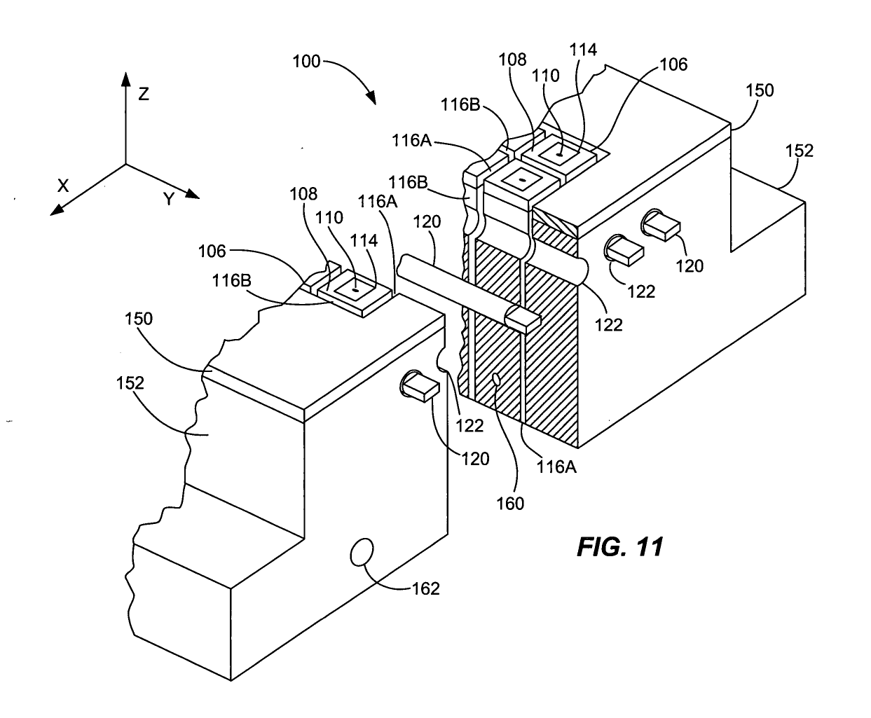

Embodiments of the invention are discussed below with reference to FIGS. 1-15. However, those skilled in the art will readily appreciate that the detailed description given herein with respect to these figures is for explanatory purposes as the invention extends beyond these limited embodiments.

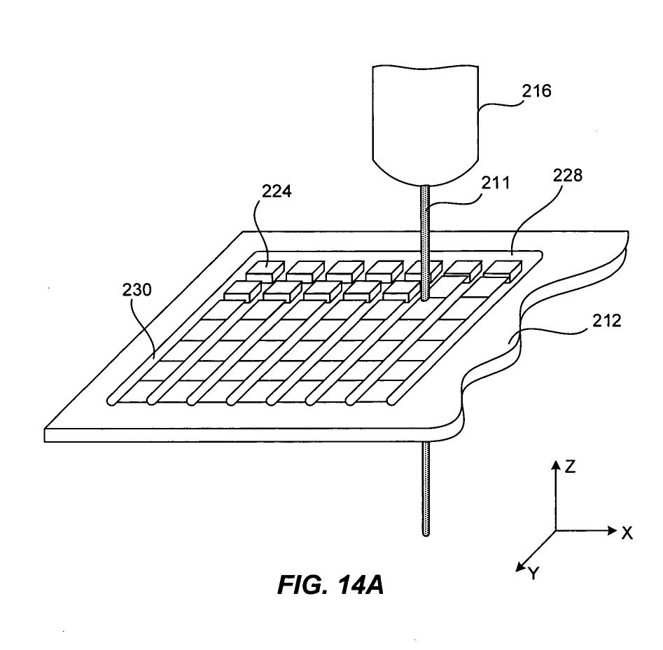

FIGS. 1A and B are diagrams of a chuck 10, in accordance with one embodiment of the present invention. The chuck 10 is configured to hold and support a planar work piece 12 before, during and after singulation with a cutting beam 14. The planar work piece 12 may for example correspond to a semiconductor work piece such as a wafer or substrate and the cutting beam 14 may for example represent a fluid jet (see FIGS. 13-15). As shown, the chuck 10 includes a surface 16 for receiving and retaining the planar work piece 12 (as well as the parts cut therefrom). The manner in which the work piece 12 is retained on the surface 16 may be implemented in a variety of ways including but not limited to vacuum, mechanical, and electrostatic means.

The chuck 10 also includes one or more cutting slots 18 disposed through the retention surface 16. The cutting slots 18, which extend into the chuck 10, are configured to receive the cutting beam 14 therethrough during a cutting sequence. That is, once the cutting beam 14 cuts through the planar work piece 12, the cutting beam 14 continues through a cutting slot(s) 18. The cutting slots 18 are typically oriented within the x-y plane as the cutting beam 14 typically operates in the z direction. The in plane configurations of the cutting slots 18 may be rectilinear having straight, stepped or angled sections or curvilinear having curved, rounded, or circular sections. The configuration may also be a combination of rectilinear and curvilinear. FIG. 1C shows an example of a rectilinear cutting slot 18A and FIG. 1D shows an example of a curvilinear cutting slot 18B.

The chuck 10 further includes openings or voids 20 disposed underneath and connected to the cutting slots 18 (the cutting slot 18 opens up into the opening 20). The openings 20 contain sacrificial members 22 that are exposed to the cutting beam 14 through the cutting slot 18. During operation, the cutting beam 14 passes through the cutting slots 18 and into the sacrificial members 22, which are housed within the chuck 10. The sacrificial members 22 are configured to resist cutting by the cutting beam 14 thereby protecting the structural members 24 of the chuck 10. In most cases, even though they resist cutting, the sacrificial members 22 erode due to the cutting action of the cutting beam 14 and therefore they wear out over time.

The sacrificial member can be made from a variety of materials. In most cases, the sacrificial members are formed from a material that can substantially withstand the cutting beam. In fluid jets, for example, the material selected generally depends on many factors including but not limited to the speed of the jet, the size of the jet, the abrasive material in the jet, the size of the abrasive material, etc. By way of example, high hardness materials such as carbide and ceramic may be used. Alternatively, the sacrificial member may be formed from multiple layers such as a core formed from a first material and an outer layer formed from a resistant material.

In most cases, the sacrificial members 22 are removable so that they can be replaced before the cutting beam 14 works its way entirely therethrough thereby preserving the structural integrity of the chuck 10. For example, once it is determined that the sacrificial members 22 are spent, the cutting sequence can be stopped and the spent sacrificial members 22 can be replaced with new sacrificial members 22 (e.g., the spent members are removed and new members are inserted into opening 20 in the chuck). Thereafter, the cutting sequence can be continued as planned. In some cases, the sacrificial members 22 may be rotatable so that more than one side of the sacrificial member 22 can be acted against thereby extending the life of the sacrificial members 22.

The sacrificial members 22 can be removed using variety of techniques. In one implementation, the sacrificial members 22 are fully enclosed and therefore they are removed by opening up the chuck 10. That is, the chuck 10 itself opens up so as to provide access to the sacrificial members 22 contained therein. By way of example, the chuck 10 may include various layers that may be dismantled in order to gain access to the sacrificial members 22. Once opened, an operator can remove the sacrificial member 22 from the opening 20 and insert a new one in its place. In another implementation, the sacrificial members 22 are partially exposed (a portion extends outside the chuck) and therefore they may be removed directly without dismantling the chuck 10. For example, they can be inserted and removed from a side of the chuck 10 without having to open up the chuck 10. In some cases, the sacrificial members are slidably received in the openings such that they may be slid in and out as needed.

Although not shown in FIG. 1, the chuck 10 may include a back-up set of sacrificial members in order to further protect the chuck 10. The back-up sacrificial members are also contained within openings in the chuck. These openings are positioned below the first set of openings and are typically connected to the upper openings via the cutting slots (the cutting slots extend between the two sets of openings). As such, when the cutting beam accidentally cuts through the primary sacrificial members, the cutting beam comes into contact with the back-up sacrificial members thereby preserving the structural integrity of the chuck.

The sacrificial members 22 whether primary or back ups are typically sized and dimension for receipt within the opening 20. In most cases, the cross sectional shape of the sacrificial member 22 substantially corresponds to the cross sectional shape of the opening 20. The cross sectional shapes of the openings/sacrificial members may be widely varied. By way of example, the cross sectional shapes may include circular, square, rectangular, triangular, oval, etc. Different shapes may provide different benefits. For example, sacrificial members 22 with a curved top surface may help temper the aggressive nature of a fluid jet 14, i.e., the curvature helps direct the cutting beam 14 around the sides of the sacrificial member 22. This may also help extend the life of the sacrificial member 22.

In some cases, there is a tight fit between the outer periphery of the sacrificial member 22 and the inner periphery of the opening 20. In other cases, the fit is more loose thereby providing some space between the outer periphery of the sacrificial member 22 and the inner periphery of the opening 20. This may be done to allow spent material as well as fluids to be disposed of therethrough. For example, in the case of a fluid jet cutting beam, the material that is eroded from the work piece 12 and sacrificial member 22 as well as the scattered fluid from the fluid jet can be transported through the opening 20 to one or more disposal channels, slots or holes 26 (shown in dashed lines). The disposal hole 26 may lead to more disposal channels, slots or holes and/or to a holding tank such as for example a fluid jet holding tank. Although not shown, a continuous or segmented channel or opening may be placed along the length of the opening 20 (e.g., a bottom surface) to help direct the material to the disposal hole 26 or to another cutting slot 18.

As mentioned above, the chuck 10 may be used to hold a work piece 12 such as a wafer or substrate. Each of these typically includes an array of closely spaced devices (e.g., dies or integrated circuit packages). In order to separate the devices from the work piece 12, the chuck 10 may include a first set of cutting slots 18A oriented in a first direction and a second set of cutting slots 18B oriented in a second direction as shown in FIG. 1E. The second direction is transverse to the first direction such that each set of cutting slots intersect or cross over one another. The intersecting cutting slots 18 may be oriented in the x and y directions or some vector component thereof (angled). By way of example, x-y, x-angled, y-angled, angled-angled orientations may be used. In most cases, the cutting slots 18 within each set are spaced apart and substantially parallel with one another. During the cutting sequence, the cutting beam 14 moves about the cutting slots 18 in order to separate each of the devices from the work piece 12. Once cut, the devices rest on pedestals 28 defined by the cutting slots 18A&B.

The configuration of the cutting slots 18 within each set may be widely varied (whether oriented in x, y or angled). In one implementation, the cutting slots 18 within each set have the same configuration. For example, all of the cutting slots 18 within a particular set may be straight (see FIG. 1E). In another implementation, at least a portion of the cutting slots 18 within each set have a different configuration. For example, the cutting slots 18 within a particular set may alternate between different configurations such as stepped cutting slots and straight or angled cutting slots. In another implementation, the cutting slots of different sets have the same configuration. For example, the cutting slots of both sets may be straight (see FIG. 1E). In yet another implementation, the cutting slots of different sets have a different configuration. For example, the first set may include stepped and angled sections as discussed above while the second set may be straight. The manner in which the cutting slots are configured generally depends on the desired shape and profile of the devices.

In one particular embodiment, and referring to FIG. 1E, the first set of cutting slots 18A are configured as described above with regards to sacrificial members 22 and the second set of cutting slots 18B extend entirely through the chuck 10 without using a sacrificial member 22. During the cutting sequence, the cutting beam continuously intersects the sacrificial member in the first direction (along its length), and intermittently intersects the sacrificial member in the second direction (transverse to its length). In the second direction, the cutting beam 14 passes entirely through the chuck 10 when it is not intersecting the transverse sacrificial member 22. In the case of a fluid jet, after intersecting the sacrificial member 22 (in either direction), the tempered fluid of the fluid jet is directed to exit out of the second set of cutting slots 18B so that it can be exhausted out of the chuck 10. It should be pointed out that in this embodiment, the pedestals 28 remain integrated with the chuck 10 since the second set of cutting slots 18B only extend partially into the chuck 10. The remaining portions of the chuck 10 underneath the cutting slots 18B support the pedestals 28 in their desired position in the chuck 10 thereby allowing the pedestals 28 to fully support the singulated devices as well as the work piece before, during and after singulation.

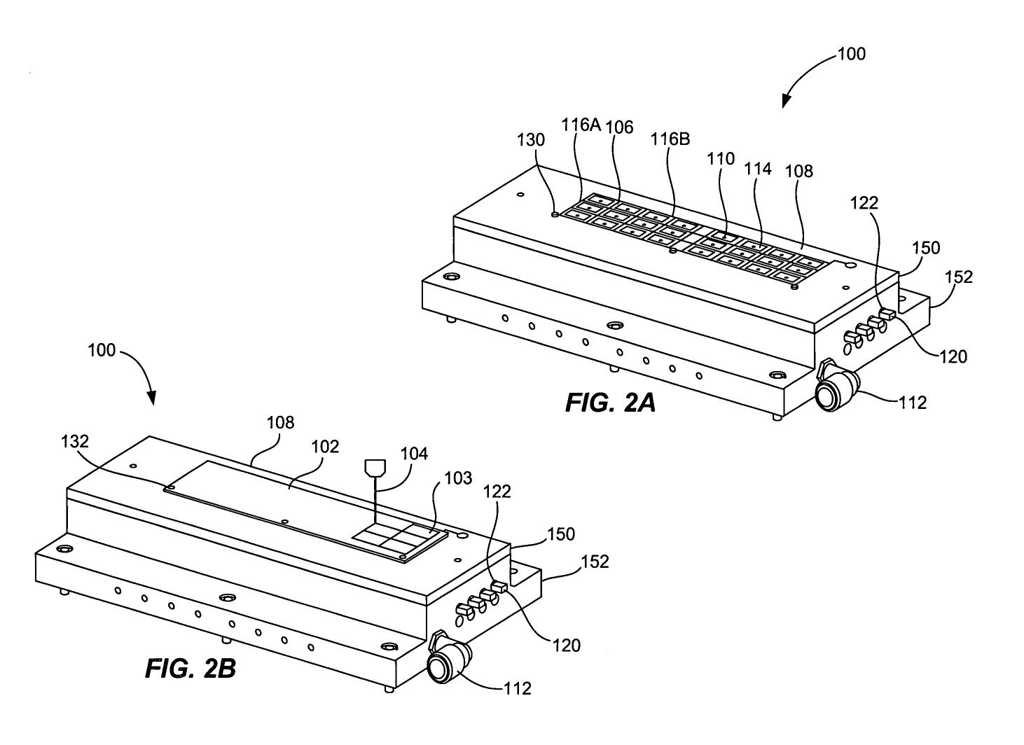

FIGS. 2-11 are diagrams of a single multidirectional chuck 100, in accordance with one embodiment of the present invention. The single chuck 100 holds and supports a planar substrate 102 such as a wafer or substrate before, during and after multidirectional singulation particularly with a cutting beam 104 such as a fluid jet. The chuck 100 is configured to allow multidirectional cutting of the planar work piece 102 thereon thereby replacing the need for multiple chucks (as for example separate x and y oriented cutting chucks) typically required for multidirectional cutting with the cutting beam 104.

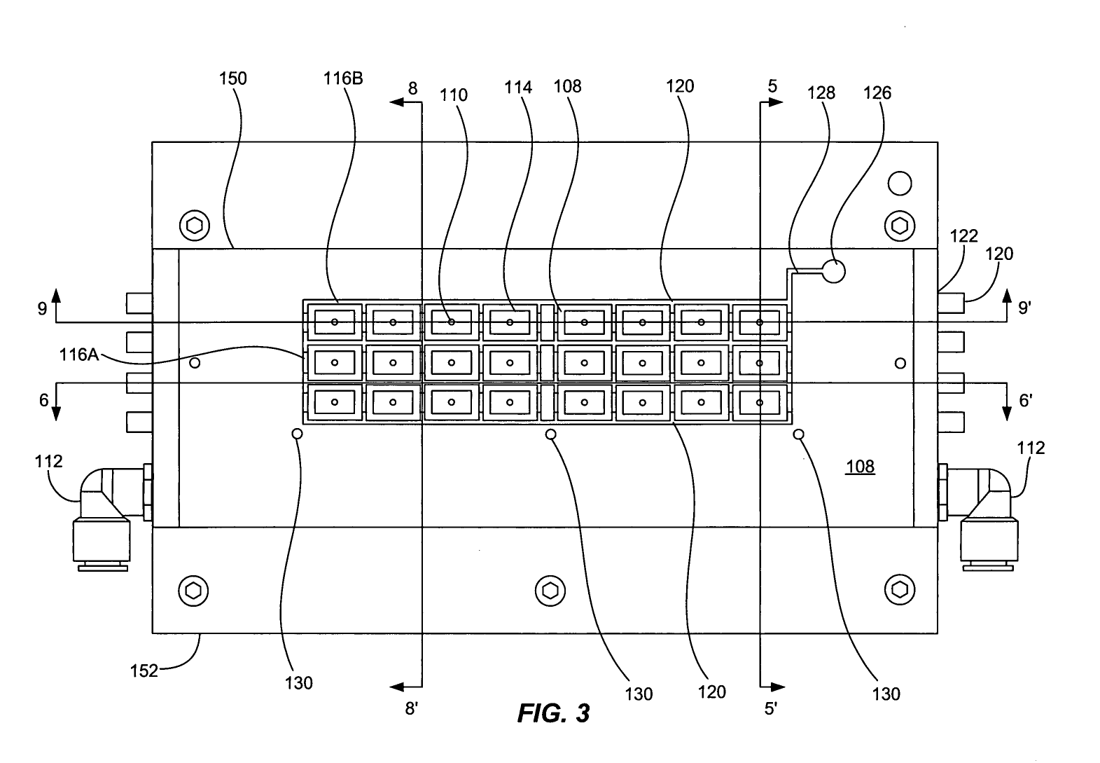

With reference to FIGS. 2A, 2B and 3, the vacuum chuck 100 includes a plurality of vacuum pedestals 106, each of which corresponds to a single device 103 to be cut from the work piece 102. The vacuum pedestals 106 are configured to apply a suction force to the substrate 102 as well as to the parts 103 cut therefrom before, during and after a cutting operation. Each vacuum pedestal 106 includes a receiving surface 108 which is substantially flat to form a vacuum seal with the under surface of the planar work piece 102 and the planar devices 103 cut therefrom. Each vacuum pedestal 106 further includes a vacuum port 110 that fluidly couples to a vacuum source through one or more vacuum outlets 112 (e.g.. fitting, coupling). During operation, the vacuum can be turned on to secure the work piece 102 as well as the devices 103 to the receiving surface 108. That is, the vacuum produces a suction force at each of the vacuum pedestals 106 that pulls the work piece 102 as well as the individual devices 103 into contact with the receiving surface 108 before, during and after the cutting operation.

The vacuum pedestals 106 may additionally include recesses 114 within the receiving surface 108 and around each of the vacuum openings 106 in order to improve the suction on the back of the work piece 102 and devices 103. The size and shape of the recesses 114 generally depends on the size and shape of the desired devices, which can vary greatly. In most cases, the recesses 114 have roughly the same shape and are sized slightly smaller than the devices so that a suction force may retain the devices. The work piece 102 and devices 103 are therefore retained on the protruding portions of the receiving surface 108 that surround the edges of the recess 114. In cases where the devices 103 have intricately configured edges (e.g., angled, stepped, curved), the recesses 114 may have a shape that more closely matches the general shape of the device 103. For example, the recesses 114 may have a substantially rectangular shape when the device 103 is substantially rectangular but with stepped or angled edges. Furthermore, because the recesses 114 help distribute a vacuum over the surface of the work piece 102 devices 103, the corners of the recesses 114 may be rounded to further aid in this distribution.

In some cases, the receiving surface 108 of the vacuum pedestals 106 may be formed of a material that readily conforms to the undersurface of the work piece 102 and devices. That is, the resilient material may be somewhat compressible to improve the seal that is formed between receiving surface 108 and the work piece 102 and devices 103 when the work piece 102 and devices 103 are disposed on the receiving surface 108 and the vacuum is turned on.

The vacuum chuck 100 also includes a plurality of cutting slots 116 disposed between the vacuum pedestals 106. The cutting slots 116 are configured to receive the cutting beam 104 therein after it passes through the work piece 102 during a cutting operation. During cutting, the cutting beam 104 is disposed within the cutting slots 116, which are present between the vacuum pedestals 106. The cutting slots 116 may be sized to permit some degree of fluctuation in side-to-side placement of the cutting beam 104 in order to prevent damage to the chuck 100 or vacuum pedestals 106. That is, cutting slots 116 may be made wider than the width of the cutting beam 104, thereby allowing some flexibility and tolerance in beam placement during cutting.

The cutting slots 116 can be arranged to produce almost any shaped parts. In most cases, the chuck 100 includes a first set of cutting slots 116A oriented in a first direction and a second set of cutting slots 116B oriented in a second direction that is transverse to the first direction. The directions may be oriented in the x, y or angled directions. The cutting slots 116 (A or B) may be rectilinear, curvilinear and may even include stepped or angled sections. Rectilinear configurations may be needed for forming individual devices such as dies and packaged ICs and curvilinear configurations may be needed for forming wave grating photonic devices. Furthermore, the cutting slots 116 within each group and for all groups may be configured the same or different. In the illustrated embodiment, the chuck 100 includes intersecting x and y oriented cutting slots 116A and 116B that are substantially straight in order to produce square or rectangular parts. It should be noted however, that “straightness” is not a limitation and that the cutting slots 116 may also be curved, stepped, angled, etc. The configuration of the cutting slots 116 depends on the desired shape of the parts.

In accordance with one embodiment, one set of the cutting slots 116 (e.g., either x or y) extends entirely through the chuck 100 such that the cutting beam 104 passes entirely through the chuck 100 in the z direction during the cutting operation and the other set of the cutting slots 116 extends partially into the chuck 110. This is done in part to ensure that the vacuum pedestals 106 are supported inside the chuck 100. If both sets of cutting slots 116 extended entirely through the chuck 100, the vacuum pedestals 106 would stand unsupported and fall through the chuck 100. By only partially extending the cutting slot 116 into the chuck 100, the remaining portions of the chuck 100 (the portions underneath the partially extended cutting slots) can be used to support the vacuum pedestals 106 in their desired position within the chuck 100.

In the illustrated embodiment, the x oriented cutting slots 116A extend entirely through the chuck 100 and the y oriented cutting slots 116B extend partially into the chuck 100. This is not a limitation however, and it should be noted that this can be reversed, i.e., the y oriented cutting slots can extend entirely through the chuck and the sacrificial rods can be positioned underneath the partially extended x oriented cutting slots. Although this is possible, it is generally preferred to place the sacrificial rods in the location that keeps them at a minimum.

In order to prevent the cutting beam 104 from cutting through the support structure of the vacuum pedestals 106, the chuck 100 also includes a plurality of removable sacrificial rods 120 positioned underneath the partially extended cutting slots 116B and within through holes 122 located inside the chuck 100. The partially extended cutting slots 116B are configured to open up to the through holes 122 thereby providing a path for the cutting beam 104 to the sacrificial rods 120 in the z direction during the cutting operation. The sacrificial rods 120 protect the support structure of the chuck 100 as well as to temper and redirect the flow of the cutting beam 104 (e.g., the curvature of the rod helps scatter and distribute the fluid around the rod). The flow of the cutting beam 104 may be further directed to the opposing set of cutting slots 116A via the through holes 122, i.e., the tempered fluid beam flows through the through hole 122 to the opposing cutting slots 116A (this set of cutting slots extends entirely through the chuck) thereby allowing the fluid beam to exit the chuck 100.

The sacrificial rods 120 are sized and dimensioned for slidable receipt within the through holes 122 thereby making them easy to insert and remove to and from the chuck 100. Furthermore, at least one end of the sacrificial rods 120 is typically left exposed on one side of the chuck 100 so that they are accessible for insertion and removal (and possibly rotating or spinning). The sacrificial rods may be formed from any suitable material that can substantially withstand the cutting action of the cutting beam. High hardness materials such as carbide may be used. In some cases, low grade carbide is used and in other cases high-grade carbide is used. The grade of carbide typically dictates the number of cutting cycles before they need to be replaced. High-grade carbide tends to last longer than low-grade carbide, however it typically is more expensive and thus a tradeoff between long lasting and price should be made when setting up the system.

The chuck 100 also includes a starting hole 126 and an entry channel 128, both of which receive the cutting beam 104 during the cutting operation. Both the starting hole 126 and entry channel 128 extend entirely through the chuck 100 such that the cutting beam 104 passes entirely through the chuck 100 during the cutting operation. The starting hole 126 provides a place for starting the cutting operation, i.e., a place for initializing the cutting beam 104. The entry channel 128 provides a path from the starting hole 126 to the cutting slots 116 so that the cutting operation can be started.

The chuck 100 also includes one or more alignment pins 130 positioned on the receiving surface 108. The alignment pins 130 are configured for aligning the work piece 102 on the receiving surface 108. The alignment pins 130 are generally configured to extend into alignment holes 132 in the work piece 102. During placement, the work piece 102 is positioned on the receiving surface 108 and the work piece 102 is aligned relative to the chuck 100 via the alignment pins 130 and alignment holes 132 interface. After placement, the vacuum is turned on, and the work piece 102 is held in place by a suction force applied through the vacuum ports 110 in the vacuum pedestals 106.

As shown in FIG. 2B, the cutting beam 104 can be driven through the cutting slots 116 around each of the vacuum pedestals 106 to separate the parts 103 from the work piece 102 (a device 103 is cut from the work piece 102 once the cutting beam 104 passes entirely around the vacuum pedestal 106). The suction force at each of the vacuum pedestals 106 holds the work piece 102 and devices 103 while the cutting beam 104 moves about the cutting slots 116. In most cases, the cutting sequence includes introducing the cutting beam 104 through the starter hole 126. Thereafter, the cutting beam 104 is directed through entry channel 128 to the cutting slots 116. This can be accomplished by moving the cutting beam 104 and/or by moving the chuck 100. Once the cutting beam 104 reaches the cutting slots 116, the cutting beam 104 can be moved about the cutting slots 116 until all (or a part) of the devices 103 are separated from the work piece 102.

The cutting path of the cutting beam 104 may be widely varied. Any cutting path can be selected because the chuck 100 allows both x and y cutting lanes. The cutting path is typically selected based on reducing the cycle time of the cutting operation. Once the devices 103 are separated from the work piece 102, the devices 103 can be removed from the chuck 100. This may be accomplished for example using a nest or a pick and place mechanism.

With reference to FIGS. 2-4, the chuck 100 may be formed from a vacuum platform 150 that is attached to a vacuum manifold 152. The vacuum platform 150 and manifold 152 work together to hold the work piece 102 and the device 103 with a vacuum as well as to allow the cutting beam 104 to be directed therethrough in the z direction. The vacuum platform 150 forms a top surface of the chuck 100, and more particularly a top surface of the vacuum pedestals 106. The vacuum manifold 152, on the other hand, provides a foundation for the chuck 100, and more particularly a foundation for the vacuum pedestals 106.

Both the vacuum platform 150 and the vacuum manifold 152 include vacuum ports 110′ and 110″ that provide a vacuum therethrough so as to hold the work piece 102 and devices 103 thereon. When attached, the vacuum ports 110′ of the vacuum platform 150 are aligned with the vacuum openings 110″ of the vacuum manifold 152. The vacuum platform 150 and vacuum manifold 152 also include cutting slots 116′ and 116″ that provide a space through which the cutting beam 104 may pass when cutting the work piece 102. When attached, the cutting slots 116′ of the vacuum platform 150 are aligned with the cutting slots 116″ of vacuum manifold 152.

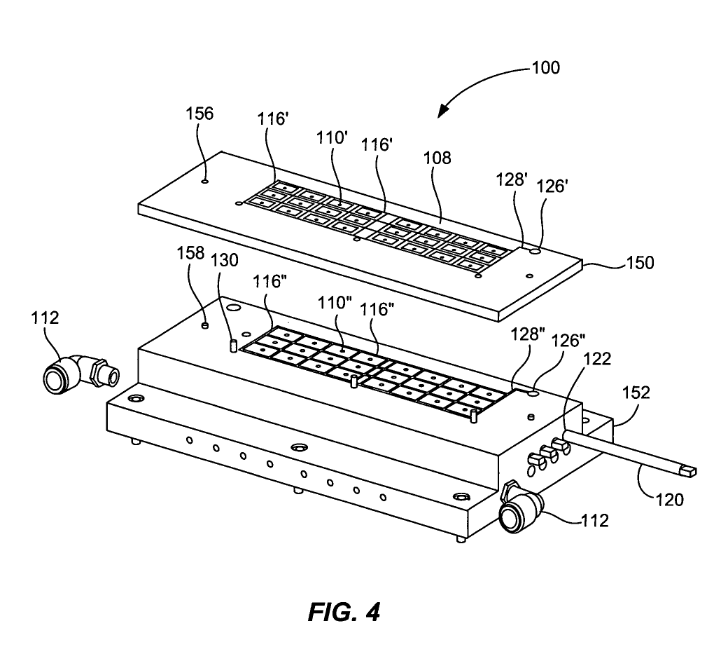

As shown in FIG. 4, the vacuum platform 150 may include alignment holes 156 that accommodate alignment pins 158 positioned on the vacuum manifold 152 in order to locate the vacuum platform 150 on the vacuum manifold 154 during assembly. The vacuum platform 150 may be attached to the vacuum manifold 152 using any suitable technique, including but not limited to fasteners such as bolts, adhesives such as glue or epoxy, welding, clamps, and the like.

In addition to the above, the vacuum manifold 152 also includes a plurality of vacuum distribution channels (see FIG. 7), which are in fluid communication with the vacuum ports 110 disposed within the individual vacuum pedestals 106. The vacuum distribution channels, which are arranged around the various cutting slots 116, fluidly couple the vacuum ports 110 to the vacuum fittings 112.

The vacuum platform 150 and vacuum manifold 152 may be formed from various materials, including but not limited to, deformable and/or rigid materials. By way of example, the vacuum platform 150 and manifold 152 may be formed from materials such as ceramics, metals, plastics, rubbers and/or the like. In one implementation, the vacuum platform 150 is formed from a rubber like material and the vacuum manifold 152 is formed from stainless steel. The vacuum platform 150 and manifolds 152 may be formed using any suitable technique including but not limited to machining, molding and the like. For example, when using stainless steel, the openings and the slots may be formed by EDM.

When selecting a material for the vacuum platform 150, it may be preferable that the vacuum platform 150 be formed from materials that are capable of withstanding the rigors of a jet stream cutting operation. Alternatively or additionally, it may be preferable that the vacuum platform material be able to withstand, for a commercially satisfactory number of cycles, the de-ionized water rinsing process that may be employed before, during and after cutting. Alternatively or additionally, it may be preferable that the vacuum platform material possess anti-static properties to prevent damage to the devices being fabricated. Alternatively or additionally, it may be preferable that the vacuum platform material possess a high friction coefficient relative to the undersurface of the work piece to prevent translational and/or rotational movement of the work piece and/or the devices during and after cutting. Alternatively or additionally, it may be preferable that the vacuum platform material provide a surface with sealing capabilities. For example, when a vacuum is applied to the device through the vacuum opening, the surface of the vacuum platform contacting the device 103 deforms to the edge of the device 103 thereby sealing the interface between the surface of the vacuum platform 150 and the surface of the device 103.

In one embodiment, at least a top layer of the vacuum platform 150 (and in some cases the entire vacuum platform) is formed from a rubber like material such as “VITON” a synthetic material available from McDowell & Company of Downey, Calif. or Pacific State Felt & Mfg. Co. Inc. of Hayward Calif. The resilient VITON material, in addition to being conformable and/or compressible, also offers substantial advantages with respect to machinability, high friction, anti-static property, relative inertness to the rinsing chemicals, and general durability when employed in the vacuum platform application. Although the term “rubberized” is used, it should be noted that the vacuum platform is not limited to rubber materials and that the term “rubberized” is used to reference some of the above-mentioned properties (e.g., sealing).

In some cases, the vacuum platform 150 is formed without cutting slots 116 disposed therein. The cutting slots 116 are cut into the vacuum platform 150 after it is attached to the vacuum manifold 152. This may be accomplished via the cutting beam 104 during an initial cutting sequence. That is, the cutting beam 104 may be used to cut through the vacuum platform 150 and form the requisite slots 116 therein. This process is much easier than attaching separate surfaces to each vacuum pedestal, and provides a ore accurate cutting path.

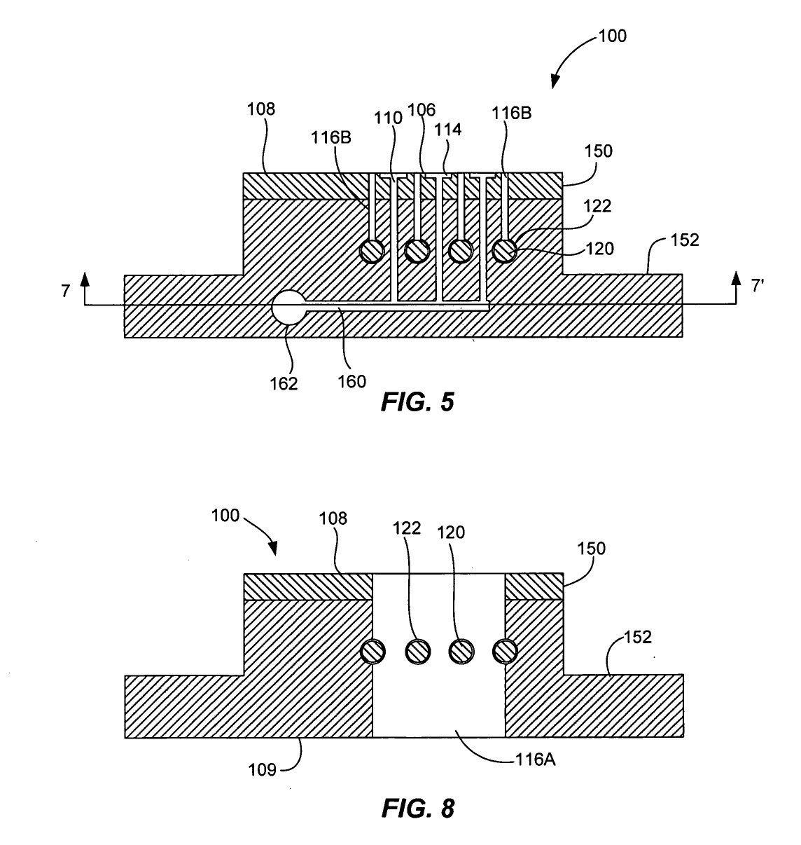

Referring to FIGS. 5-6 and 10-11, the y oriented cutting slots 116B extend in the z direction from the receiving surface 108 to the through hole 122 located within the chuck 100 and more particularly the vacuum manifold 152. The cutting slots 116B are configured to have a width greater than the width of the cutting beam 104 to ensure that the cutting beam 104 does not come in contact with the chuck 100 during the cutting operation. The through holes 122, which contain the sacrificial rods 120 sized and dimension for receipt within the through holes 122, are configured to have a width greater than the width of the cutting slot 116B to ensure that the sacrificial rod 120 receives the entire cutting beam 104 during the cutting operation. In cases where the cutting slot is stepped or curved, the through hole and thus sacrificial rods may be configured with a width at least as large as the width profile of the entire cutting slot including the curved and stepped sections so as to ensure that the sacrificial rod is located underneath each section of the cutting slot. In most cases, the centerline of the cutting slot 116B is aligned with the centerline of the through hole 122 (although this is not a requirement).

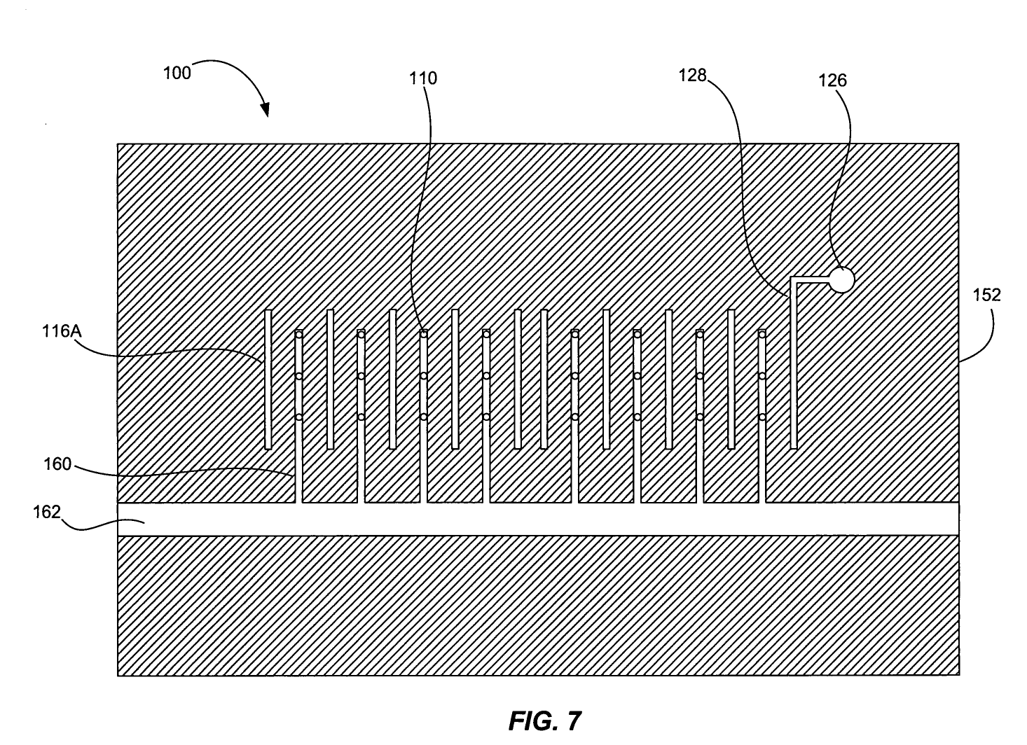

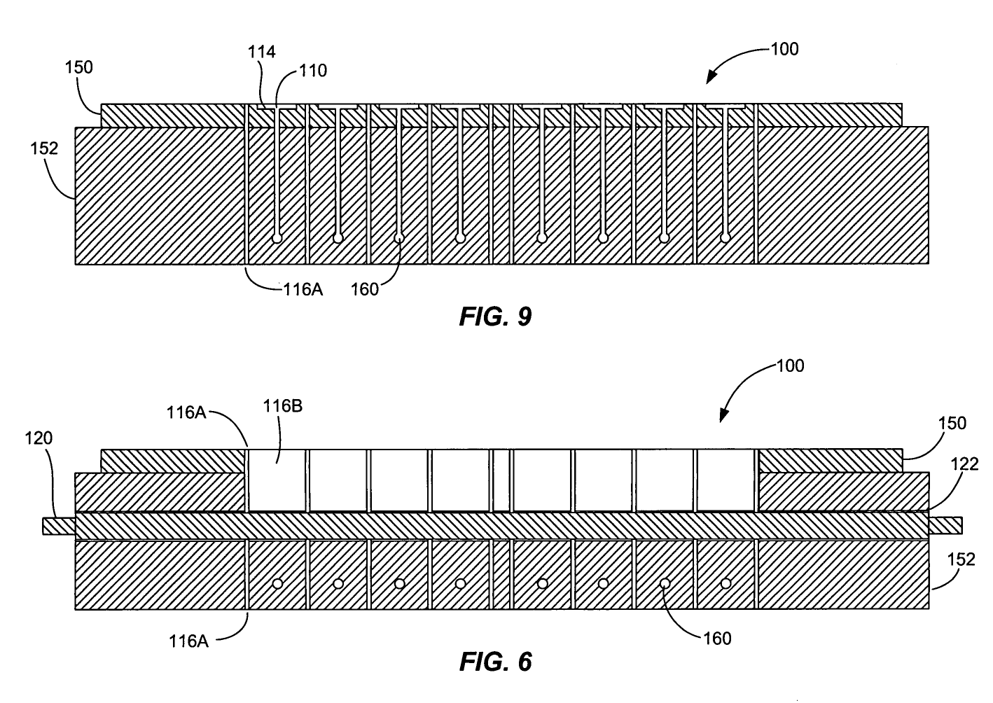

As shown in FIG. 6, the through holes 122 and sacrificial rods 120 extend from one side to an opposing side of the chuck 100 underneath the y oriented cutting slot 116B. The ends of the sacrificial rods 120 extend past the end of the through holes such that they can be manipulated for removal, insertion and spinning. During the cutting operation, the cutting beam 104 continuously contacts the sacrificial rod 120 as it is moved through the y oriented cutting slot 116B. Furthermore, the x oriented cutting slot 116A cuts through the through hole 122. The fluid, which has intersected with the sacrificial rod 120 during a y-oriented cut, is directed through the through hole 122 and into the x oriented cutting slot 116A where it can exit the chuck 100.

In addition to the above, the vacuum ports 110 for each vacuum pedestal 106 extends through the vacuum platform 150 and partially into the vacuum manifold 152. The vacuum ports 110 fluidly couple to a sub vacuum channel 160 that services each row of vacuum pedestals 106. Each of the sub channels 160 fluidly couples to a main vacuum 162 that services all the sub vacuum channels 160. The main channel 162 extends through the chuck 100, and more particularly the vacuum manifold 152 in the y direction to both sides of the chuck 100 where they couple to the vacuum fittings 112. As shown, the vacuum ports extend in the z direction past the through holes 122 (deeper into the chuck than the cutting slots and through holes), and the sub channels 160 extend in the x direction underneath the through holes 122 where they meet up with the main channel 162 that extends in the y direction.

Referring to FIG. 7, the vacuum system will be described in greater detail. As shown, the sub channels 160 are positioned between the x oriented cutting slots 116A underneath the vacuum posts 110. The sub channels 160 fluidly couple to the main channel 162 that extends in the y direction. In this particular figure, the y oriented cutting slots 116B, through holes 122 and sacrificial rods 120 are not shown because this particular cross section is disposed below them. The main channel 162 extends through the chuck 100 from one side to the other. At each end of the main channel 162 are vacuum fittings 112 that couple to a vacuum source.

When a vacuum exists within the main channel 162, as for example when vacuum lines are connected to the vacuum fittings and the vacuum is turned on, each vacuum port 110 of the vacuum pedestal 106 provides suction force to hold down the work piece and devices during the cutting operation. Because there are fittings on both sides, the vacuum is more evenly distributed through the subchannels and thus the vacuum ports. In essence, one side serves the first half of sub channels 160 and the other side serves the second half of sub channels 160. As should be appreciated, if only one side were used, the vacuum applied through each sub channel would get incrementally smaller. As a result, the suction force at the receiving surface would vary, and this may lead to problems holding the work piece and devices 103.

Referring to FIGS. 8-11, the x oriented cutting slots 116A extend entirely through the chuck 100 from the receiving surface 108 to a bottom surface 109 of the chuck 100. The cutting beam 104 can therefore pass entirely through the chuck 100 when moved within the x oriented cutting slot 116A except when it intersects the sacrificial rods that extend therethrough in the y direction. During a cutting operation through the cutting slot 116A, the cutting beam intersects the rods and then it passes through the rods, intersects the rods and then through the rods, etc. When it intersects, the cutting beam 104 bombards the sacrificial rod 120 where it is tempered and redirected around the surfaces of the sacrificial rod 120. Thereafter, it exits through the x oriented cutting slot 116A.

In addition to the above, the vacuum ports 110 for each vacuum pedestal 106 extends through the vacuum platform 150 and partially into the vacuum manifold 152 between the x oriented cutting slots 116A. The vacuum ports 110 fluidly couple to a sub vacuum channel 160 that services each row of vacuum pedestals 106. The sub vacuum channels are also positioned between the x oriented cutting slots 116A.

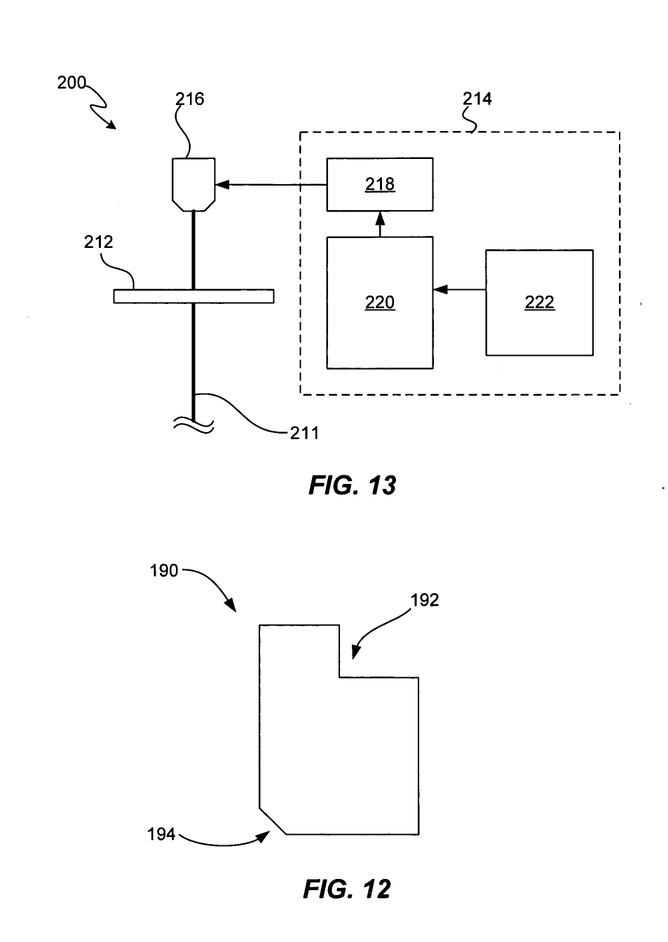

Although the pedestals 106 are primarily shown as being rectangular, it should be appreciated that this is not a limitation and that the pedestals may be formed as other shapes including for example simple shapes such as squares, triangles, circles, etc. or more complex shapes that include rectilinear or curvilinear edges. By way of example, FIG. 12 is a top view diagram of a pedestal 190 that includes a stepped upper surface 192 and an angled section 194 at one of its lower corners.

FIG. 13 is a simplified block diagram of an exemplary cutting apparatus 200, in accordance with one embodiment of the present invention. The cutting apparatus 200 may for example be used with the various chucks described above. The cutting apparatus 200 is configured to produce a cutting beam 211 capable of cutting through a substrate 212 in order to form small discrete parts. For example, the cutting beam may be configured to singulate a wafer into dies or a substrate into a plurality of individual packaged devices including but not limited to CSPs, BGAs, QFNs and the like. The cutting beam may also be configured to singulate a substrate into photonic devices such as arrayed wave grating photonic devices.

The cutting apparatus 200 generally includes an abrasive delivery system 214 and a nozzle 216 operatively coupled to the abrasive delivery system 214. The abrasive delivery system 214 is configured to supply an abrasive slurry to the nozzle 216 and the nozzle 216 is configured to produce a cutting beam 211 with the abrasive slurry. An abrasive and a fluid typically form the abrasive slurry. The cutting nature of the beam 211 relies on the fluid to carry the abrasive and on the abrasive to remove the material from the substrate 212. In most cases, the abrasive slurry is squeezed through a small opening in the nozzle 216. Squeezing the slurry through the nozzle 216 causes it to exit the nozzle 216 in a very fine and high speed cutting beam 211.

As shown in FIG. 13, the abrasive delivery system 214 generally includes a pump 218, a slurry vessel 220 and a slurry source 222. The pump 218 is configured to pump the abrasive slurry out of the slurry vessel 220 and deliver the abrasive slurry to the nozzle 16. The slurry vessel 220 is configured to contain the abrasive slurry and may serve as a location for mixing the components (e.g., abrasive and fluid) of the abrasive slurry. The slurry source 222, on the other hand, is configured to supply the components of the abrasive slurry. For example, the slurry source may distribute the abrasive, fluid, or other component of the slurry separately and/or mixed. The slurry source may for example include storage containers that contain the individual or mixed components of the abrasive slurry. The components may be pumped into the slurry vessel using any suitable technique.

The diameter of the cutting beam 211 is small in order to dice small parts such as packaged or photonic devices. The cutting beam 211 typically produces cut widths in the substrate with similar dimensions as the diameter of the cutting beam. The diameter of the cutting beam is generally determined by the diameter of the opening in the nozzle. The diameter of the cutting beam generally corresponds to the diameter of the opening in the nozzle. Although not a requirement, the diameter of the beam is typically on the order of about 0.050 mm to about 3.0 mm, and more particularly between about 0.25 mm and about 0.3 mm. This range is well within the typically saw street dimensions for packaged and photonic devices.

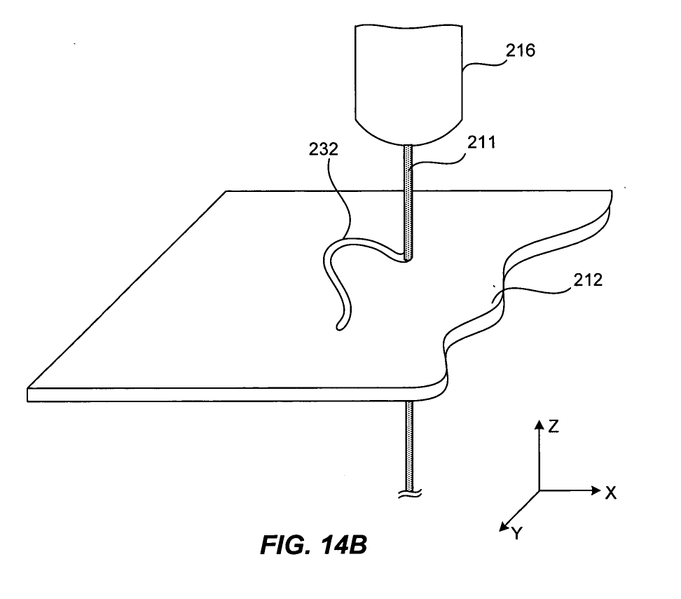

As shown in FIGS. 14A and 14B, the cutting beam 211 may be used to make rectilinear cuts (FIG. 14A) as for example when forming individual packaged devices and/or curvilinear cuts (FIG. 14B) as for example when forming wave grating photonic devices. These types of cuts may be accomplished by moving the substrate 212 and/or the cutting beam 211 relative to one another. For example, the substrate 212 may be moved by a stage and/or the nozzle 216 may be moved by a robot.

In FIG. 14A, the z axis oriented beam 211 is moved in the x direction to make parallel rows of x directed rectilinear cuts 228, and in the y direction to make parallel rows of y directed rectilinear cuts 230. Rectilinear cuts such as x and y directed cuts are suitable for singulating individual packaged devices 224 such as CSPs, BGAs, QFNs and the like. One advantage of cutting package devices with this type of cutting method is that the cutting beam interacts with the substrate along the z-axis thereby preventing the formation of shear forces that can adversely effect the singulated packages. In FIG. 14B, the z-axis oriented beam 211 is moved in both the x and y directions (simultaneously or incrementally) in order to make curvilinear cuts.

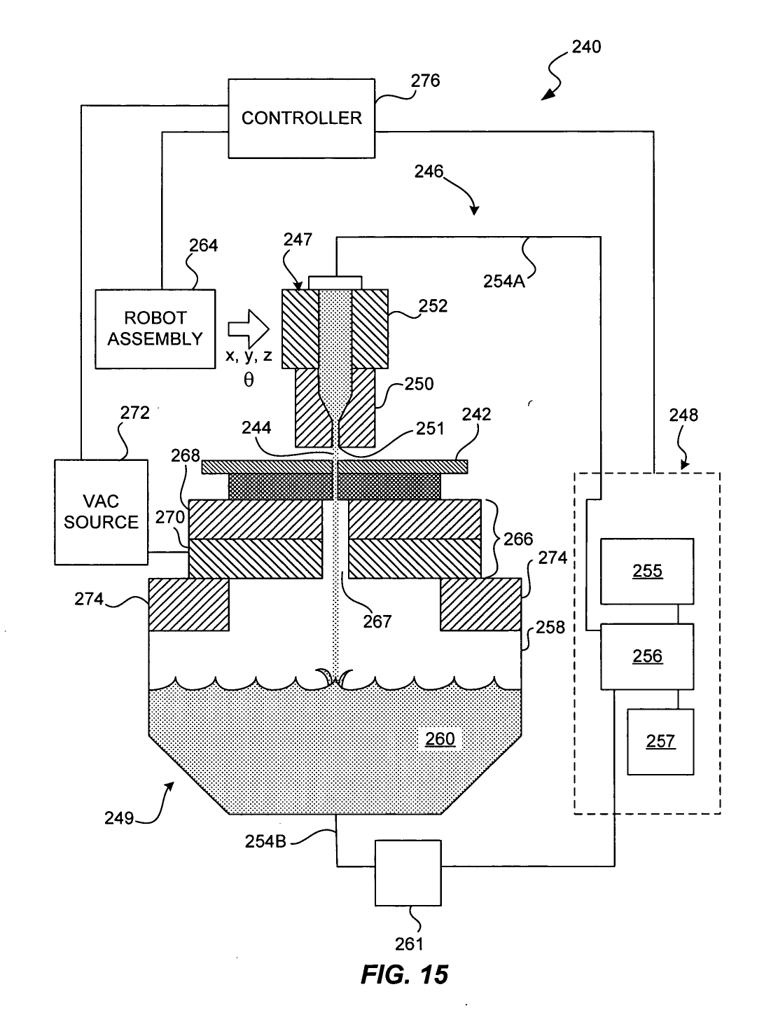

FIG. 15 is a simplified diagram of a singulation engine 240, in accordance with one embodiment of the present invention. The singulation engine 240 is configured to singulate a substrate 42 into smaller component parts via a cutting beam 244. By way of example, the component parts may be CSPs, BGAs, QFNs, photonic devices and the like. The singulation engine 240 includes a jet stream distribution unit 246 formed by at least a nozzle assembly 247, an abrasive slurry delivery assembly 248 and a tank assembly 249. The abrasive slurry delivery assembly 248 is configured to deliver an abrasive slurry to the nozzle assembly 247. The nozzle assembly 247 is configured to discharge a jet stream in a laminar and collimated manner towards the substrate 242 in order to produce the cutting action of the cutting beam 244. The tank assembly 249 is configured to receive and diffuse the jet stream once it passes through the substrate 242 during the cutting action.

During operation, for example, the abrasive slurry delivery assembly 248 supplies the nozzle assembly 247 with the abrasive slurry and the nozzle assembly 247 directs the abrasive slurry towards the substrate 242. Once discharged from the nozzle assembly 247, the abrasives in the slurry work against the substrate 242 to remove material therefrom. Almost instantaneously, the cutting beam 244 forms a hole through the substrate 242. After forming the hole, the cutting beam 244 continues along its path until it reaches a medium stored in the tank assembly 249.

The nozzle assembly 247, abrasive slurry delivery assembly 248 and tank assembly 249 may be widely varied. In the illustrated embodiment, the nozzle assembly 247 includes one or more nozzles 250 coupled to a nozzle manifold 252. The one or more nozzles 250 are configured to direct the abrasive slurry towards the substrate 242 in the form of one or more cutting beams 244. Each of the nozzles 250 includes an opening 251 through which the abrasive slurry is discharged. The size of the opening 251 generally effects the size of the cutting beam 244, which in turn effects the width of the cut in the substrate 242. The nozzle manifold 252 is configured to distribute the abrasive slurry from the abrasive delivery system 248 to the one or more nozzles 250. As shown, the nozzle manifold 252 is coupled to the abrasive slurry delivery system 48 via one or more tubes 54A. The number of nozzles and thus the number of cutting beams may vary according to the specific needs of each device.

The abrasive delivery assembly 248, on the other hand, includes a high-pressure pump 255, an abrasive slurry vessel 256, and an abrasive slurry source 257. The high-pressure pump 255 is configured to pump fluid to the abrasive slurry vessel 256 in order to carry and deliver the abrasive slurry to the nozzle assembly 247 at very high pressures. By way of example, the high-pressure pump may pressurize the slurry vessel with pressures ranging between about 1,000 PSI to about 50,000 PSI. The slurry vessel 256 is configured to contain the abrasive slurry before being sent to the nozzle assembly 247 and may serve as a location for mixing the components (e.g., abrasive and fluid) of the abrasive slurry. The slurry source 257 is configured to supply the components of the abrasive slurry. The abrasive is generally introduced into the slurry vessel 256 at low pressures as for example between about 10 and about 75 PSI. The slurry source 257 may be a re-circulatory and/or non circulatory system. That is, the slurry source 257 may supply previous used abrasive slurry and/or it may supply new components to the abrasive slurry vessel.

It has been found that the slurry should be completely devoid of air in order to maintain small diameter cutting beams as for example 50 micron cutting beams. In one implementation, the abrasive is first soaked with water at ambient pressure as it is introduced into the singulation system. The wet abrasive is then introduced into the slurry vessel 256 and exposed to high-pressure water via the high pressure pump. Once the abrasive/water mixture is pressurized, the abrasive slurry moves through high-pressure tubing 254A to the nozzle assembly 247.

Referring to the tank assembly 249, the tank assembly 249 typically includes a holding tank 258, which contains a medium 260 for diffusing the jet stream. The medium may for example correspond to a slurry such as the abrasive slurry used to cut the substrate. In some cases, the abrasive slurry is mixed and held in the holding tank 258 before being sent to the abrasive slurry vessel 256. For example, the holding tank 258 may serve as the abrasive slurry source for the abrasive delivery assembly 48. In cases such as these, the holding tank 258 may include one or more inlets/outlets for refilling and removing the components of the abrasive slurry. Furthermore, the holding tank 258 may be coupled to the abrasive slurry delivery assembly 248 and more particularly the slurry vessel via one more tubes 254B. In order to prevent contaminants (caused by the cutting action) from entering the abrasive slurry delivery assembly 248, a filter mechanism 261 may be placed between the holding tank 258 and the abrasive delivery assembly 248.

The abrasive slurry may be widely varied. The abrasive slurry is typically formed by an abrasive and a fluid. The abrasive and fluid may be selected from any suitable material or medium. By way of example, an abrasive such as Al₂O₃ or garnet and a fluid such as water may be used. The type of material selected depends on many factors including but not limited to cutting ability and cost. Generally speaking, gamet provides good cutting ability at reasonable cost while Al₂O₃ provides better cutting ability at higher cost. The size of the abrasive used generally depends on the size (diameter) of the opening in the nozzle. The size of the abrasive generally ranges between about 1/10 and about ½ the diameter of the opening in the nozzle, and more particularly about ¼ the diameter of the opening in the nozzle. Furthermore, the percentage of abrasive to water (by weight) is generally between about 1% and about 200%, more particularly between about 10% and about 100% and even more particularly about 40%

The substrate 242 and cutting beam 244 are generally moved relative to one another in order to produce a linear cutting path (e.g., rectilinear and/or curvilinear). For example, the cutting beam 244 and/or the substrate 242 may be moved. The method of moving may be widely varied. In the illustrated embodiment, the singulation engine 240 includes a robot assembly 264 capable of moving the nozzle assembly 247. For example, the robot assembly 264 may include a transfer arm that is attached to the manifold 252 of the nozzle assembly 247. The robot assembly 264 may provide linear movements in the x, y and z directions as well as rotations about the x, y and z axis. In most cases, the robot assembly 264 moves the nozzle assembly 247 within a single plane along a desired cutting path so that all or any selected part of the substrate 242 may be cut by the cutting beam 244 (e.g., x, y and θ_{z}). When cutting integrated circuit packages, the robot assembly 264 may make one or more passes in the x direction and one or more passes in the y direction in order to cut the substrate 242 into integrated circuit packages. The robot assembly 264 may also be arranged to move in a serpentine fashion. The robot assembly 264 may be widely varied. For example, the robot assembly 264 may consist of linear actuators (servos, steppers), SCARA robots and the like. In one particular embodiment, a SCARA robot assembly is used. By way of example, SCARA robot assemblies manufactured by Epson Robots of Carson, Calif. may be used.

The singulation engine 240 also includes a chuck 266 configured to support and hold the substrate 242 and the parts cut therefrom before, during and after singulation. The chuck may for example correspond to a single multidirectional chuck shown in the previous Figures. As shown, the chuck 266 includes one or more openings 267 disposed therethrough. The openings 267 allow the cutting beam 244 to flow past the substrate 242, through the chuck 266, and to the slurry stored in the holding tank 258. The opening configuration generally provides a path that corresponds to the cutting path produced by the robot assembly 264. For example, it may be formed as a linear opening in the x and/or y directions. The openings may include one large continuous opening or a plurality of discontinuous openings. A continuous opening typically has the advantage that the cutting beam can follow its cutting path without being stopped. The width of the opening 267 is typically larger than the diameter of the cutting beam 244.

The singulation engine 240 may also include a controller 276 for controlling the various components of the singulation engine 240. For example, the controller 276 may include capabilities for, but not limited to, controlling the movement of nozzle 250 via the robot assembly 264, controlling the flow of the slurry 260 via the pump 256, controlling the vacuum that holds the substrate 242 via the vacuum source 272, and the like. The controller 276 may be arranged to act as an operator console and master controller of the system. That is, all system interfaces with an operator and the user's facilities may be made through the controller. Commands may be issued to and status may be monitored from all components so as to facilitate completion of operator assigned tasks. By way of example, the controller may include a keyboard for accepting operator inputs, a monitor for providing visual displays, a database for storing reference information, and the like.

In one embodiment, the controller 276 is configured to initiate a cutting sequence. During the cutting sequence, the controller may cause the cutting beam to turn on and off while the nozzle and thus the cutting beam moves via the robot assembly. A continuous cutting sequence may be implemented where the cutting beam is continuously produced while the robot assembly moves the nozzle along a path. During a continuous cutting sequence, for example, the cutting beam may be turned on when moving in a first direction (e.g., x) as well as a second direction (e.g., y). In addition, an incremental cutting sequence may be implemented where the cutting beam is turned on and off incrementally while the robot assembly moves the nozzle along a path. During an incremental cutting sequence, for example, the cutting beam may be turned on when moving in a first direction (e.g., x) and turned off when moving in a second direction (e.g., y).

A method of producing integrated circuit packages (product by process) will now be discussed. By way of example, the integrated circuit package may be any one of those previously described. The method generally begins by forming a plurality of integrated circuit packages on a substrate. Once the packages are formed on the substrate, the substrate is cut with a cutting beam in order to separate the individual integrated circuit packages from the substrate. This may be accomplished with the one or more jet streams that are made incident on the surface of the substrate and that are configured to cut through the substrate. The jet streams are generally configured to move in a manner that cuts the integrated circuit packages as for example into rectangles or squares.

The substrate may be cut using a variety of techniques. One such technique will now be discussed with reference to FIG. 15. The substrates are typically received and loaded into the singulation engine, as for example, at a loading dock of the singulation engine. Once received, the substrates 242 are placed on the chuck 266 by a transfer assembly (not shown). During placement, the substrates 242 are aligned to a reference surface (e.g., alignment pins) and secured or held to the top surface of the chuck 266 using a suction force produced by the vacuum source 272. Thereafter, the nozzle assembly 247 is moved into a starting position relative to the substrate 242 held on the chuck 266. Once in position, the abrasive slurry delivery system 248 delivers the abrasive slurry to the nozzle assembly 247 and the abrasive slurry is subsequently squeezed out the nozzles 250. The abrasive slurry is forced into a jet stream that strikes and cuts through the substrate 242 while the substrate 242 is held by the chuck 266. The nozzle assembly and thus the jet stream is then moved along a cutting path via the robot assembly 264 in order to separate the integrated circuit packages from the substrate. During the cutting sequence, the abrasive slurry in the jet stream is collected in the holding tank 258 after passing through the substrate 242 and the opening 267 in the chuck 266.

While this invention has been described in terms of several preferred embodiments, there are alterations, permutations, and equivalents, which fall within the scope of this invention. It should also be noted that there are many alternative ways of implementing the methods and apparatuses of the present invention. For example, although the invention has been described in terms of processing integrated circuits (in all its various forms), it should be noted that the invention may be used to process any device. For example, the invention may be used to process semiconductor wafers. In addition, the invention may be used to process discrete electrical components such as resistors, transistors, capacitors and the like. The invention may also be used to process biotechnological devices, optical devices, opto-electrical devices, electromechanical devices (e.g., MEMS-micro electro-mechanical) or the like. Moreover, although the single multidirectional chuck has been directed at water jet singulation, it may also be used in other types of singulation. Particularly singulation methods that use a cutting beam such as for example laser singulation. It is therefore intended that the following appended claims be interpreted as including all such alterations, permutations, and equivalents as fall within the true spirit and scope of the present invention.

What is claimed is:

1. A chuck having a top surface for receiving and retaining a planar work piece thereon during a cutting operation, and a plurality of cutting slots disposed through the top surface, the cutting slots receiving a cutting beam therein during a cutting operation, at least a first set of the cutting slots intersecting an opening disposed inside the chuck, each of the openings including a sacrificial member therein, the sacrificial member providing cutting resistance to the cutting beam when the cutting beam intersects the sacrificial member through the cutting slots.

2. The chuck as recited in claim 1 wherein the cutting slots are configured to extend into the chuck in the z direction and are oriented in the X-Y plane.

3. The chuck as recited in claim 2 wherein the in plane path of the cutting slots are rectilinear.

4. The chuck as recited in claim 2 wherein the in plane path includes stepped or angled sections.

5. The chuck as recited in claim 2 wherein the in plane configuration of the cutting slots are curvilinear.

6. The chuck as recited in claim 1 wherein the sacrificial members have an outer surface formed from carbide.

7. The chuck as recited in claim 1 wherein the entire sacrificial member is formed from carbide.

8. The chuck as recited in claim 1 further including a second set of openings disposed underneath the first set of openings and further intersecting the cutting slots, the second set of openings including a back up set of sacrificial members.

9. The chuck as recited in claim 1 wherein the chuck is configured to hold a planar work piece that includes an array of closely spaced devices.

10. A single multidirectional vacuum chuck configured to hold a work piece and parts cut therefrom before, during and after singulation with a cutting beam, the single multidirectional vacuum chuck comprising:
a base having a plurality of vacuum pedestals and a plurality of cutting slots disposed between the vacuum pedestals, each of the vacuum pedestals including a vacuum port, a first set of cutting slots being oriented in a first direction, a second set of cutting slots being oriented in a second direction that is transverse to the first direction, the first set of cutting slots extending entirely through the base such that the cutting beam passes entirely through the base during a cutting operation, the second set of cutting slots extending partially into the base, the second set of cutting slots opening up to openings located within the base, the openings including removable sacrificial members therein that protect the structural integrity of the base and that temper and redirect the cutting beam out of the base.

11. The single multidirectional vacuum chuck as recited in claim 1 wherein the sacrificial members have an outer surface formed from carbide.

12. The single multidirectional vacuum chuck as recited in claim 1 wherein the entire sacrificial member is formed from carbide.

13. The single multidirectional vacuum chuck as recited in claim 1 wherein the sacrificial members are circular rods.

14. The single multidirectional vacuum chuck as recited in claim 1 wherein the work piece corresponds to a semiconductor wafer or substrate.

15. The single multidirectional vacuum chuck as recited in claim 1 wherein the vacuum pedestals include a receiving surface and a recess disposed within the receiving surface.

16. The single multidirectional vacuum chuck as recited in claim 1 wherein the receiving surface is formed from a compressible material.

17. The single multidirectional vacuum chuck as recited in claim 1 wherein the openings are through holes, and wherein the sacrificial members are rods that are sized and dimensioned for slidable receipt within the through holes, the through holes extending entirely through the base.

18. A plurality of integrated circuit devices formed by a singulation method comprising:
providing a single multidirectional chuck having a first set of cutting slots oriented in a first direction and a second set of cutting slots oriented in a second direction such that they cross the first set of cutting slots, at least the second set of cutting slots providing paths to sacrificial members located inside the chuck;
disposing a planar work piece on the single multidirectional chuck, the planar work piece having the plurality of integrated circuit devices formed thereon;
holding the planar work piece against an upper surface of the single multidirectional chuck with a vacuum;
generating a cutting beam; and
cutting the work piece into the plurality of integrated circuit devices with the cutting beam while the work piece is held against the upper surface of the single multidirectional chuck, the cutting beam being directed about the cutting slots in order to separate the plurality of integrated circuit devices from the work piece, the cutting beam intersecting the sacrificial members when the cutting beam is directed though the second set of cutting slots.

19. A method of cutting with a cutting beam, comprising:
providing a retention force for holding a work piece on a surface; and
receiving the cutting beam through openings in the surface and against a sacrificial member disposed underneath the surface.
